(19) United States
(12) Patent Application Publication
(10) Pub. No.: US 2002/0170190 A1
(43) Pub. Date: Nov. 21, 2002

(54) Spotting device

(76) Inventor: David A. Wetterlind, East Bethel, MN (US)

Correspondence Address: ROBERT A PAJAK, PATENT SERVICES, 14234 NAPLES STREET NE, HAM LAKE, MN, 55304

(21) Appl. No.: 09/860,006

(22) Filed: May 17, 2001

(51) Int. Cl. G01C 15/00; G01B 5/24

(52) U.S. Cl. 33/286; 33/412

(57) ABSTRACT

A spotting device for use in pipe fitting and construction trades includes a generally housing having a beam emitting end and an opposing coupling end. The housing is defined in part by a central longitudinal axis passing through the beam emitting end and the coupling end. A visible light beam emitting means is located within the housing for selected emission of a visible light beam from the beam emitting end of the housing. The emission of the visible light beam is provided such that the light beam projects from the beam emitting end concentrically with the central longitudinal axis.

### FIELD OF THE INVENTION

The present invention relates generally to spotting devices. Specifically, the invention relates to spotting devices adaptable for use in various construction applications such as pipe fitting and the like, where a visible light beam is projected from a location of a pipe to another location.

### BACKGROUND OF THE INVENTION

In the construction trades, there exists a continual need for accurately and efficiently determining one location with respect to a fixed, existing location. In this regard, and particularly in pipe fitting, it is often required that a proposed pipe installation line or “run” be provided in a manner that does not physically interfere with other construction components such as structural support members, ceiling tiles, and existing pipe runs, to name a few.

Past methods of determining whether a pipe run interferes with another installation have largely been variations of simple trial-and-error, such as by attempting to measure various distances and clearances using a tape measure or a rigid pole or stick, or by sighting a run along a pipe held in position by a worker, or even simply by “eyeballing” the run and presuming (or hoping) that it will not be interfered with by other structures. Clearly, such trial-and-error methods are fraught with difficulties, are inefficient, and are essentially fruitless in large or complex constructions.

In attempts to provide a modicum of accuracy in determining one location with respect to another relative to construction applications, several devices have been proposed.

For example, in U.S. Pat. No. 5,287,627 entitled “AUTOMATIC PLUMB AND LEVEL TOOL WITH ACOUSTIC MEASURING CAPABILITY” issued to Rando, a visible laser diode projects a beam from the tool for use in plumbing and leveling operations. The device has a further use of projecting a pointing beam for use in alignment or layout.

In U.S. Pat. No. 5,359,781 entitled “SELF CENTERING PIPE AXIS LASER GUIDE AND SADDLE” issued to Melville, a laser beam is provided to be aligned with a center axis of a pipe by way of a supporting guide that is held in place within the pipe via an expandable link apparatus. The axially aligned laser beam is then used for target-type monitoring of an elevation of the center axis during pipe installation.

In U.S. Pat. No. 5,394,616 entitled “LASER POSITIONING DEVICE” issued to Claxton, a positioning device utilizes a laser beam generator for solving positioning problems associated with measurement, alignment, pathway location or identification, and orienting, as occurring in the construction trades such as plumbing.

The known devices suffer several drawbacks, however, particularly in pipe fitting tasks such as locating sprinkler runs. Specifically, the known devices are generally cumbersome, heavy, and are not readily adapted to small-diameter pipe installations. Many such devices also require an operator to target or otherwise align a light beam emitted from the devices through various adjustment means on the devices themselves.

Thus, there exists a need for a spotting device that is compact and lightweight, that does not require any appreciable operator manipulation for its use, and that is easily adapted to small-diameter pipe installations.

### SUMMARY OF THE INVENTION

An object of the present invention is to provide a spotting device that accurately determines a location with respect to a fixed or known location.

Another object of the present invention is to provide a spotting device that accurately determines a proposed pipe run.

In accordance with the present invention, a spotting device includes a generally cylindrical housing having a beam emitting end and an opposing coupling end. A visible light beam emitter is provided within the housing. The emitter provides, in operation, projection of a visible light beam from the emitting end of the housing. The emitter is oriented within the housing such that the emitted light beam is concentric with a central longitudinal axis of the housing. Threads are provided at the coupling end of the housing for coupling the housing to an existing compatibly threaded receiving pipe.

### BRIEF DESCRIPTION OF THE DRAWINGS

FIG. 1 is a transparent perspective illustration of a spotting device constructed in accordance with the present invention.

FIG. 2 is a perspective illustration of an alternative embodiment of the spotting device constructed in accordance with the present invention.

### DETAILED DESCRIPTION OF THE INVENTION

In the following exposition, the word “spotting” is intended to include, but not be limited to, any function or task of spotting or accurately locating a position with respect to a fixed or known position.

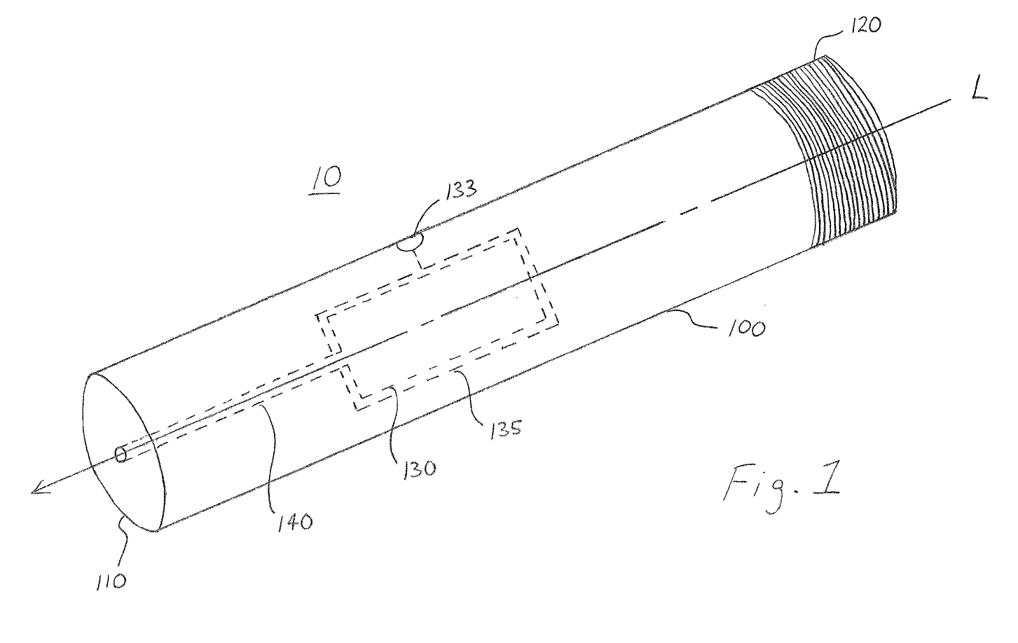

Referring to FIG. 1, thereshown is a spotting device 10 of the present invention. Spotting device 10 includes a generally cylindrical housing 100 having a beam emitting end 110 and an opposing coupling end 120. As will be further described, spotting device 10 also includes a visible light emitting means 130 that is energized by way of an external push-on switch 133. Visible light emitting means 130 is contained with a housing cavity 135, and a light channel 140 in communication with visible light emitting means 130 and beam emitting end 110.

Housing 100, being generally cylindrical, has a central longitudinal axis (reference axis L in the drawing) that extends through beam emitting end 110 and a threaded coupling end 120.

In construction of spotting device 10, solid, round or cylindrical aluminum stock is preferably utilized for housing 100, having typical dimensions of 12″ in length and 1¼″ in outside diameter. The length dimension of 12″ provides a comfortable “user friendly” handling quality of device 10, and the 1½″ O. D. provides for application to a typical commercial fire-fighting sprinkler installation (as will be described in use of device 10). The aluminum stock is then machined or milled to provide cavity 135 for visible light emitting means 130. Similarly, light channel 140 is also provided in housing 100 by machining or milling. In a preferred construction of device 10, the provision of cavity 135 and channel 140 is made with particular regard to longitudinal axis L. That is, channel 140 is provided to be axially concentric with axis L, and cavity 135 is provided so that light emitting means 130 may, in operation of device 10, provide a light beam that is correspondingly concentric with axis L and channel 140.

Preferably, light emitting means 130 is a commercially available battery-powered laser light device. Light emitting means 130 is then secured within cavity 135 such that light emitted therefrom may be conducted through channel 140 without interference. In this manner, a precise, coherent visible light beam projects from device 10 in operation thereof, in concentric alignment with axis L.

In an example of a pipe fitting application of device 10, a user first screws threaded coupling end 120 of housing 100 about axis L into a complimentarily threaded receiving pipe (not illustrated). It is to be appreciated, then, that device 10 so coupled to a receiving pipe effectively defines a longitudinal extension of the receiving pipe, relative to axis L. The user then activates light emitting means 130 by way of switch 133. Light emitting means 130 then, responsively, generates and outputs a coherent beam of visible light, which is in turn conducted through channel 140 and is projected from device 10 along axis L. The light then impinges upon a first surface that intersects axis L. Of course, a distance of such a first surface from device 10 (and also, the composition of the surface) determines whether the light impinging thereupon may be visible to the user. Usually, in the case of a commercially available laser used for light emitting means 130, any opaque surface up to a distance of greater than 100 feet away from emitting end 110 will be seen by a user in a spotting operation of device 10.

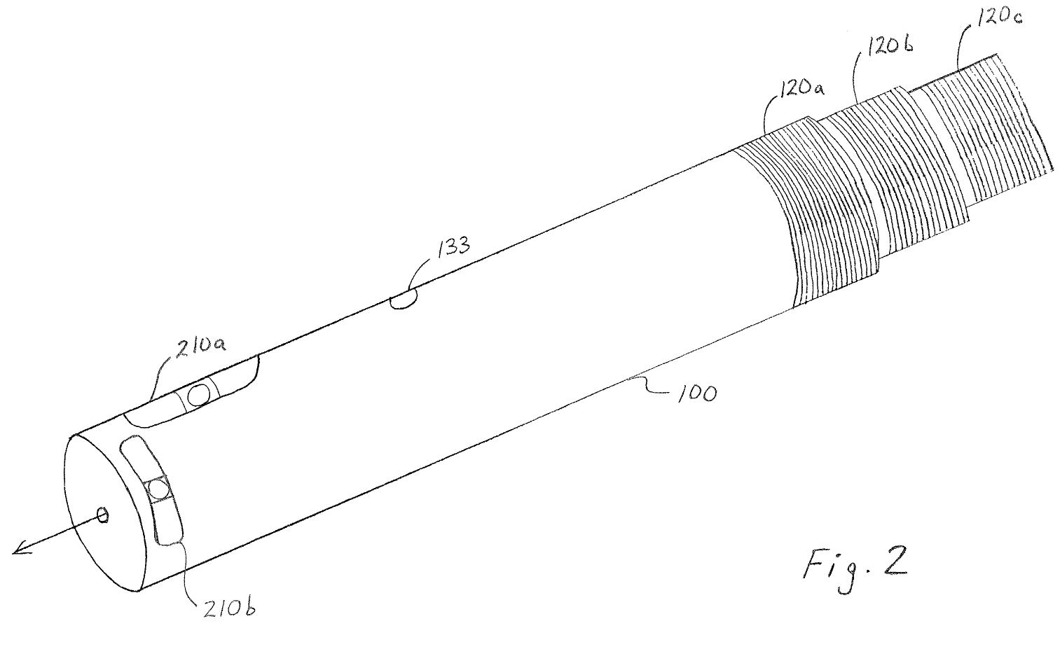

In FIG. 2, several modifications to device 10 are depicted. Therein, housing 100 includes a pair of level indicator means 210a and 210b, for leveling indications for device 10. Preferably, level indicator means 210a and 210b are conventional “bubble” levels that are coupled to housing 100 by any suitable technique, such as by machining corresponding cavities in housing 100 for containing the level indicator means therewithin, or by simply adhering the level indicator means to the housing directly via an adhesive bonding agent. Of course, as known to those experienced in use of such indicators, level indicator means 210a-b must be provided on housing 100 such that they are, respectively, parallel and orthogonal to axis L (as shown and described in FIG. 1).

Additionally in FIG. 2, a set of three threaded coupling ends 120a, 120b, and 120c are depicted. Again, housing 100 is preferably machined or milled such that decreasing diameters are provided in device 10 in a step-down fashion. In an exemplary embodiment of device 10, threaded coupling ends 120a-c have outside diameters of 2″, 1¼″, and 1¼″, respectively, to accommodate a typical range of pipe diameters. It is to be appreciated that the provision of ends 120a-c obviates a need for a collection of devices 10, and that any number of decreasing diameter threaded ends could be provided, depending upon the requirements of a particular pipe fitter. It is to be further appreciated that, alternatively, a simple bushing-type arrangement (not illustrated) could be substituted for ends 120a-c, so that an individual end of a desired diameter could be simply inserted into housing 100. Such a replaceable bushing arrangement would have an advantage of minimizing a length of housing 100 that would otherwise exist with permanent ends 120a-c.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto, or that alternative uses of the invention may be realized.

For example, in the exemplary device 10 of FIG. 2, either or both of level indicators 210a-b could be provided by way of an audible tone level indicator (such as taught in U.S. Pat. No. 5,313,713) so that a level condition of device 10 may be discernable even in dim ambient light conditions in which it would be difficult to visually “read” a bubble level.

Also, device 10 is intended to be capable of any number of uses, as known to those in the pipe fitting and construction trades, such as for (i) coupling to a fitting in a ceiling grid to spot or locate positions for fire-suppression sprinkler heads, (ii) spotting hanger lengths, (iii) determining chases through walls, and (iv) providing plumb bob type leveling functions.

It is to be understood that any suitable alternatives may be employed to provide the spotting device of the present invention. For example, housing 100 could be constructed from any durable material, whether metallic or plastic-like, such as brass, acrylic, or an injection-molded plastic material. Further, housing 100 could be any suitable geometric shape (e.g., rectangular, spherical, or cubic) having a central longitudinal axis concentrically aligned with the light beam emitted in operation of device 10.

Lastly, the choice, of course, of compositions, sizes, and strengths of various aforementioned components of the spotting device of the present invention are all a matter of design choice depending upon intended uses of the present invention.

Accordingly, these and other various changes or modifications in form and detail of the present invention may also be made therein, again without departing from the true spirit and scope of the invention as defined by the appended claims.

What is claimed is:

1. A spotting device, comprising:
a housing having (i) a beam emitting end and an opposing coupling end, and (ii) a central longitudinal axis passing through said beam emitting end and said coupling end; and
at least one visible light beam emitting means located within said housing for selected emission of a visible light beam from said beam emitting end thereof,
wherein said visible light emitting means is oriented such that said visible light beam projects from said beam emitting end concentrically with said central longitudinal axis.

2. The spotting device of claim 1, further comprising at least one level indicator means within said housing, for providing an indication of a level condition of said spotting device.

3. The spotting device of claim 2, wherein said at least one level indicator means comprises an audible tone level indicator.

4. The spotting device of claim 1, further comprising at least one set of pipe threads disposed about said coupling end of said housing, such that said spotting device is capable of being threadably coupled to a receiving pipe.

5. The spotting device of claim 4, wherein said at least one set of pipe threads comprises a plurality of concentric sets of pipe threads of decreasing diameter, as measured from said beam emitting end to said coupling end of said housing.

6. The spotting device of claim 4, further comprising a removable bushing means for removable coupling of said at least one set of pipe threads to said coupling end of said housing.
